(19) United States
(12) Patent Application Publication
(10) Pub. No.: US 2006/0019225 A1
(43) Pub. Date: Jan. 26, 2006

(54) Method for long-term behavior change in humans

(76) Inventor: Morton C. Orman, Sparks, MD (US)

Correspondence Address: Royal W. Craig;Law Offices of Royal W. Craig, Suite 153, 10 N. Calvert Street, Baltimore, MD, 21202, US

(21) Appl. No.: 11/187,769

(22) Filed: Jul. 23, 2005

Related U.S. Application Data
(60) Provisional application No. 60/590,728, filed on Jul. 23, 2004.

(51) Int. Cl. G09B 19/00

(52) U.S. Cl. 434/236

(57) ABSTRACT

A method for encouraging behavior change consisting of three phases of steps: an extended preparation phase, a behavior change phase, and a maintenance/relapse prevention phase that may be used to supplement traditional human behavior modification programs, thereby improving their outcomes. The extended preparation phase is designed to help an individual develop the essential skill of keeping his/her word consistently. To accomplish this goal, physical exercise is preferably used as a training ground to help an individual recognize and overcome any psychological and emotional barriers to keeping his/her word. Once word-keeping mastery has been achieved in the physical exercise context, an individual transfers this skill to active behavior change, such as weight loss, smoking cessation, gambling avoidance, etc. Once targeted goals are reached, a long-term maintenance/relapse prevention phase begins. During all three phases, physical exercise is used in a novel manner to strengthen and reinforce daily word-keeping mastery.

### CROSS-REFERENCE TO RELATED APPLICATION(S)

The present application derives priority from U.S. Provisional Application No. 60/590,728 filed Jul. 23, 2004.

### BACKGROUND OF THE INVENTION

1. Field of the Invention

The present invention relates to a method for implementing psychological, emotional, and/or physiological changes in humans and, more particularly, to a method for changing an individual's long-term behavior that minimizes, if not eliminates, the probability of relapse into undesirable behavior patterns.

2. Description of the Background

Classic behavior modification theory holds that there are six key phases, or steps, to successful human behavior change. As shown in FIG. 1, these include the steps of pre-contemplation 12, contemplation 14, preparation 16, action 18, maintenance 20, and relapse prevention 22. While this classic model, or process 10, is widely accepted, significant variations exist in the methods used to assist people in moving from pre-contemplation, to contemplation, to successful action, and then to maintaining new behaviors over time.

Examples of behavioral modification methods are disclosed in U.S. Patent Application Publication No. 2004/0016437 to Cobb et al. and U.S. Pat. Nos. 5,967,789 to Segel et al.; 5,908,301 to Lutz; 5,722,418 to Bro; 5,340,315 to Kaye; 4,853,854 to Behar et al.; and 4,734,038 to Dennis.

U.S. Patent Application Publication No. 2004/0016437 to Cobb et al. discloses a method for delivering information over a network including; a) monitoring an action of a user on the network to obtain observed user data relating to a desired behavior modification; b) obtaining user supplied data relating to the desired behavior modification; c) evaluating the observed user data and the user supplied data to generate tailored information for progressing a user towards the desired behavior modification; d) presenting the tailored information to the user over the network; and e) repeating steps a), b), c) and d) until the desired behavior modification is achieved. The user is continually provided with re-tailored information resulting from an iterative process of obtaining and evaluating data that progresses the user towards a desired behavior modification, such as the cessation of smoking.

U.S. Pat. No. 5,967,789 to Segel et al. discloses a system and method for helping a person to stop or modify an adverse habitual health-related behavior (e.g., smoking) by following a calculated regimen to commence on a day to be selected by the person. The system comprises a computer and a series of customized visually perceptible messages establishing a customized regimen to aid the person to stop or modify the adverse habitual health-related behavior. The customized messages are in the form of a daily sequence measured relative to day selected by the person for the regimen to begin. The messages produced by the system may be updated and modified based upon information provided to the system by the person.

U.S. Pat. No. 5,908,301 to Lutz discloses an interactive pre-set and adjustable behavior modification device suitable for encouraging modification of various behaviors, such as reduced or increased food intake, or tobacco use. The device monitors, and if selected by a user, adjusts, any behavior sequence which includes behavior actions and behavior intervals. It has a multiple output signals alerting a user of when to begin the next behavior action; when the pre-determined number of behavior actions has been attained; when the pre-determined number of behavior actions is being exceeded; and a special alert signal. The device is configured to accept, and modify automatically or manually, a user's intended goal and the rate at which the user desires to attain the goal.

U.S. Pat. No. 5,722,418 to Bro discloses a method for mediating social and behavioral influence processes through an interactive telecommunications guidance system that utilizes an expert such as a physician, counselor, manager, supervisor, trainer, or peer in association with a computer that produces and sends a series of motivational messages and/or questions to a client, patient or employee for changing or reinforcing a specific behavioral problem and goal management. The system consists of a client database and a client program that includes for each client unique motivational messages and/or questions based on a model such as the transtheoretical model of change comprising the six stages of behavioral change and the 14 processes of change, as intertwining, interacting variables in the modification of health, mental health, and work site behaviors of the client or employee.

U.S. Pat. No. 5,340,315 to Kaye discloses a method of treating obesity comprising a screening phase, a reducing phase, an adaptive phase, and a sustaining phase. The method of treatment involves not only nutrition, but also instruction and involvement in exercise and personal effectiveness.

U.S. Pat. No. 4,853,854 to Behar et al. discloses a human behavior modification method and apparatus that aid in withdrawing from a particular habit. A behavioral event such as smoking a cigarette may be associated with the habit numerous times over a period of time. The present method and apparatus provides a structured environment which enables one to reduce the occurrence rate of such behavioral events over a period of time in a way specifically personalized to characteristics of the user's habit.

U.S. Pat. No. 4,734,038 to Dennis discloses a learning method comprising the steps of; selecting the particular ideal behavior to be achieved; defining the steps to be taken to effectuate the modification; assigning a mnemonic device for each step to promote mental identification of the step; and providing a visual image of a role model for behavioral emulation wherein the role model acts out the defined steps. The method further includes the steps of simultaneously providing an auditory cue with the visual image to reduce distracting influences directed towards the person and posterizing the image to eliminate the visual personality and characteristics of the role model.

Thus, as demonstrated by the prior art references disclosed above, there are many different strategies and methods available today to produce human behavior change. Unfortunately, few of these methods have proven to be consistently successful. For example, statistics show that, regardless of the type of weight loss program people enter, more than 95% of all participants weigh the same, or more, two years later. Alcohol and drug addiction programs are similarly ineffective, with low cure rates and frequent episodes of relapse. The same is true for smoking cessation programs, sexual addiction programs, gambling addiction programs, and other behavior modification endeavors.

None of the prior art methods for behavior modification empower an individual to keep his/her word consistently. For any human being to change an established, undesirable behavior pattern, the ability to give and keep one's word, to oneself, on a daily basis is absolutely essential. While many behavior change programs highlight the importance of this personal skill, none are specifically designed to produce it, nor require that it be demonstrated before allowing an individual to embark upon a specific behavior change plan of action.

In addition, the preparation phases of most behavior change programs fail to give an individual the proper types of education, motivation, and strategies for long-term success that are needed to overcome the massive failure rates such programs have historically produced.

Furthermore, in recent years, social support has become a hallmark of human behavior change. Well-known programs such as Weight Watchers, Alcoholics Anonymous and other multi-step programs, and virtually every other behavior change program strongly endorse the value and benefits of social support. However, the problem with these programs is that they require an individual to attend regular meetings indefinitely, while providing little or no support between meetings. Even when telephonic or computer-mediated personal support is substituted for face-to-face social gatherings, dependency upon some type of support-giver is a major component of the overall program design. This design feature makes most behavior change and maintenance programs costly and labor-intensive, thereby making them ill-suited for handling large numbers of participants.

Therefore, each of the prior methods falls short of the optimum for accomplishing long-term behavioral change, and there is a critical need for new and more effective methods. The need is accentuated by the growing depth of problems which stem from certain undesirable behaviors, such as overeating, excessive gambling, etc. The growing obesity problem in this country, both in adults and children, has received significant press and governmental attention in recent years. For example, the 2002 Surgeon General's Report establishes obesity as a national health priority. In this report, the U.S. Surgeon General calls upon the nation to work together in finding solutions to the problem of obesity and overweight.

To the best of the knowledge of the present inventor, no existing method addresses this nor any of the other problems outlined above. Consequently, there remains a significant need for a new method that improves the quality and effectiveness of human behavior change programs. Such a method would ideally be implemented through a program of education and instruction delivered to the public, which: (1) significantly improves the success rate of behavior modification by empowering people to keep their word consistently, (2) improves upon the quality and effectiveness of behavior change education and instruction delivered to the public, (3) is entirely independent of social support for either short-term or long-term success; and (4) can be applied to a wide variety of behavioral change goals such as weight loss, smoking cessation, exercise programs, etc.

### SUMMARY OF THE INVENTION

It is, therefore, an object of the present invention to provide an improved method for human behavioral change that significantly increases the probability of long-term success by empowering people to keep their word consistently.

A further object of the present invention is to provide a method for human behavioral change that improves the quality and effectiveness of a behavior change program implemented through a program of education and instruction delivered to the public.

Another object of the present invention is to provide a method for human behavioral change that is entirely independent of social support for either short-term or long-term success.

Another object of the present invention is to provide a method for human behavioral change that may be used to supplement traditional human behavior modification programs, thereby improving their outcomes.

It is still another object to provide a method for human behavioral change that can be applied to a wide variety of undesirable behaviors such as weight loss, smoking cessation, etc.

These and other objects are accomplished by a method for implementing behavior change beginning with an extended preparation phase, and progressing to a behavior change phase, then a maintenance/relapse prevention phase. The present invention differentiates itself from the prior art, with respect to the preparation, behavior change phase, and maintenance/relapse prevention stages of classical behavior change philosophy (see FIG. 1), by reorientation of the individual through a combination of goal-setting and game play.

Initially, the individual develops the essential skill of keeping his/her word consistently by goal-setting, followed by personal discovery of one's psychological and emotional barriers to achieving the goals, and by reorientation to a game-play scenario by association of said barriers to “gremlins”, whereby the individual battles specific gremlins rather than generic obstacles. “Gremlins” may be of any of the following specific types: set-up, false belief, emotional, physical sensation, injury, discomfort, demoralizing, disempowering, completion, life circumstance/events, family, other people, long-term success, and unique/individual. The reorientation to game-play encourages the individual to think of behavior change as consisting of three separate yet interconnected “games”;

the keep your word game,

the reach your goal game, and

the maintain your success game.

Each of these games has different rules and requires a different set of skills and strategies to succeed. In order to succeed at long-term behavior change, an individual must learn how to master each of these three distinct games.

Moreover, the game-play approach is first implemented in an exercise context—the use of physical exercise helping the individual learn how to give and keep his/her word on a consistent daily basis. This serves as a powerful training ground to assist an individual in discovering the means to identify and overcome the psychological and emotional barriers that prevent him/her from keeping his/her word.

Once this type of personal discovery process and word-keeping success is achieved in the physical exercise arena, an individual then transfers the very same skill-set and self-awareness to the keeping of daily promises associated with food intake, smoking behavior, sexual behavior, gambling behavior, etc. In addition, they are provided with a new and improved “game plan” for long-term behavior change success. Once goals have been achieved, an individual moves on to a long-term maintenance/relapse prevention phase.

Unlike conventional programs, the behavior change method of the present invention is entirely independent of social support. This method is structured such that once an individual completes the essential core learning elements, he/she will be able to achieve and maintain long-term behavior change totally on his/her own.

By providing an enhanced, extended preparation phase focusing on building word-keeping skills, along with improved behavior change, maintenance, and relapse-prevention education, the method of the present invention can be implemented as a standalone program or as a supplement to existing behavior change programs/strategies to produce better long-term results.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flowchart of the prior art, classic method 10 for human behavioral change.

FIG. 2 is a flowchart of a method 100 for human behavioral change according to a preferred embodiment of the present invention.

FIG. 3 is a flowchart of a preparation phase 110 according to a preferred embodiment of the present invention.

FIG. 4 is a flowchart of a behavior change phase 120 according to a preferred embodiment of the present invention.

FIG. 5 is a flowchart of a maintenance/relapse prevention phase 130 according to a preferred embodiment of the present invention.

### DETAILED DESCRIPTION OF THE PREFERRED EMBODIMENTS

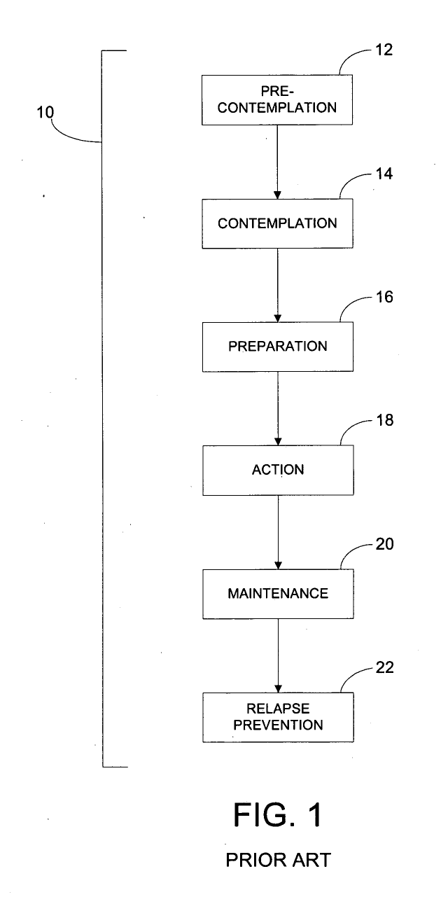

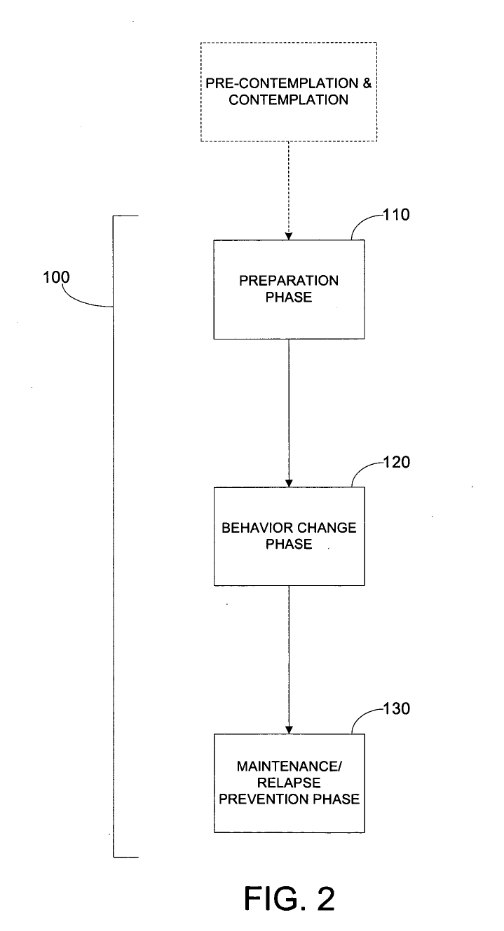

With contrast to the prior art classical method 10 for human behavioral change of FIG. 1 (which generally includes the steps of Pre-Contemplation 12, Contemplation 14, Preparation 16, Action 18, Maintenance 20, and Relapse Prevention 22), FIG. 2 is a flowchart of a method 100 for behavior change according to a preferred embodiment of the present invention.

The present method 100 generally comprises an extended preparation phase 110, a behavior change phase 120, and a maintenance/relapse prevention phase 130, and differentiates itself from the prior art by reorienting the subject to succeeding at long-term behavior change using quantification of daily goals and game play. The enhanced behavior change method 100 of the present invention improves the efficacy of the Preparation 16, Action 18, Maintenance 20, and Relapse Prevention 22 steps of FIG. 1. The behavior change method 100 of the present invention does not exclude the pre-contemplation and contemplation steps 12, 14 of FIG. 1, but rather assumes that the subject has already graduated through these steps, and thus begin at a point where they are already willing to consider changing their behavior. Thus, the present method may be used to supplement traditional human behavior modification programs which begin with these steps (as well as used as a standalone program), in both cases improving outcomes.

Referring back to present method 100 of FIG. 2, the preparation phase 110 is designed to help an individual develop the essential skill of keeping his/her word consistently. To achieve this goal, physical exercise is preferably used as a training ground to help an individual recognize and overcome any psychological and emotional barriers to keeping his/her word. Once word-keeping mastery has been achieved in the physical exercise context, an individual then moves on to an active behavior change phase 120, in which he/she selects and implements specific behavior change strategies tailored to achieve individual “targeted” goals, such as weight loss, smoking cessation, gambling avoidance, etc. Once targeted goals are reached, a long-term maintenance/relapse prevention phase 130 begins, during which an individual learns how to maintain his/her success and avoid returning to prior behavior patterns. During all three phases 110-130 of the method 100 of the present invention, physical exercise is used in a unique and novel manner to strengthen an individual's ability to give and keep his/her word on a consistent daily basis.

Before being accepted for participation in the method 100, an individual is subjected to an orientation and screening process comprising multiple elements. These elements include, but are not limited to; (1) completion of a detailed application form, (2) completion of a health history questionnaire, and (3) obtaining from his/her primary care providers any required medical and/or psychological clearance to participate in the method 100.

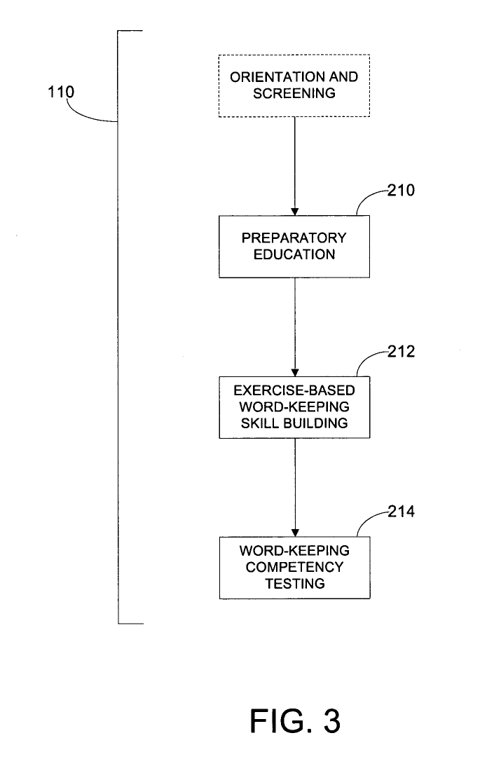

If accepted for completion, the individual begins the preparation phase 110. As shown in the flowchart of FIG. 3, the preparation phase 110 comprises three steps; (1) preparatory education 210, (2) exercise based word-keeping skill-building 212, and (3) word-keeping competency testing 214.

At the orientation and screening step, an individual is introduced to the purpose, rationale, and content of the method 100 of the present invention, after which he/she can elect to participate. The following outline presents the topics covered in a typical orientation session:

A. Background of traditional human behavior modification programs

B. History of this method's inventor and the development of the invention

C. The central importance of giving and keeping one's word

D. Why behavior change programs that do not powerfully address giving and keeping one's word are likely to fail

E. The value of physical exercise as a means to practice and master one's ability to give and keep one's word

F. Why traditional strategies to motivate and inspire people to change unhealthy behaviors are well-intended, but misguided

G. Why traditional strategies for behavior change maintenance and relapse prevention are well-intended, but misguided

H. Introduction to the three “inner games” of behavior change: a) the “keep your word” game, b) the “reach your goal” game; and c) the “maintain your success” game

I. An overview of the method's structure and the contents of each training phase

J. The rules and requirements for participating and completing the program

K. The dates of upcoming available programs

L. How the benefits of participating in this program can expand to many different areas of an individual's life (in addition to the one or more targeted behavioral areas)

M. How and when to register in the program

N. Legal disclaimers, risks of physical exercise, psychological and emotional risks of participation, and need for physician and mental health provider (where appropriate) approval as a pre-requisite for participation

At the preparatory education step 210, an individual learns about the six classic stages of behavior change (see FIG. 1), explores the reasons why most conventional behavior change methods are destined to fail, and is introduced to two core principles of the present method: 1) quantification of internal barriers/obstacles to keeping your word; and 2) game-play reorientation of internal barriers/obstacles using the concept of “gremlins.” For example, if an individual is tempted to watch TV rather than exercise, the TV temptation is identified and labeled as a gremlin, effectively reorienting the individual to combat this temptation. This is not an intuitive approach, and training as to how to combat different types of “gremlins” is necessary as described below. Nevertheless, the concept is introduced at this stage, and the individual begins to understand what is required to win the “keep your word” game. The following outline presents the topics included as part of a typical education step 210:

A. Central importance of keeping your word

B. Internal barriers/obstacles to keeping your word (gremlins)

C. The three inner games of behavior change
1. “Keep your word” game
2. “Reach your goal” game
3. “Maintain your success” game

D. How to win the three inner games of behavior change
1. To win games #2 and #3, the individual first must learn how to win the “keep your word” game (KYW)
2. The skills required to win each game are different
3. The individual has no choice about whether or not to play the KYW game—the individual is already playing it!
4. Regarding the KYW game, here is what the individual must do to win
   a. Understand the nature of the game: (you—i.e. your word vs. gremlins)
   b. Understand the rules of the game (gremlins don't play fairly)
   c. Understand who your opponent is (your specific gremlins)
   d. Understand the strategies/tactics your opponent has been using to defeat you (classic gremlin moves and strategies are enumerated)
   e. Understand both the strengths and weaknesses of yourself and your opponent (the power of gremlins is mostly illusory)
   f. Understand the strategies that will enable an individual to defeat his/her opponent (specific strategies and game plans are discussed)
   g. Set up a daily practice routine that requires the individual to give and keep your word and which forces his/her opponent's tactics and weaknesses to become obvious (daily physical exercise is employed for this purpose)
   h. Go out each day and start collecting “wins” (the object of the game is to give your word about something specific each day and then keep your word no matter what transpires in your life that day)
   i. Keep collecting “wins” each day, day after day, week after week, month after month, until your confidence in your ability to give and keep your word becomes firmly established in your mind and in your body.

Next, at the skill-building step 212, which may also be referred to as “Word-Keeping Basic Training”, an individual engages in daily physical exercise, not for the purpose of physical fitness or general health benefits, but rather to learn how to identify and overcome the internal (i.e. psychological, emotional) and external barriers that routinely prevent him/her from keeping his/her word on a consistent, daily basis. The following outline presents the topics included as part of a typical skill-building step 212:

A. Introduction to using physical exercise in a new and different way
1. As a daily routine to practice giving and keeping your word
2. As a daily routine to force your gremlins' tricks into the open
3. As a daily routine to begin accumulating “wins” in the area of giving and keeping your word
4. As a daily routine to begin changing your self-image and self-confidence regarding your ability to give and keep your word consistently, no matter what else happens in your life

B. Obtain clearance from your personal physician to participate in a daily exercise program (required prior to engaging in this step of the method)

C. Select a type of exercise of interest

D. Select a type of exercise that either the individual already enjoys or that the individual would like to discover how to enjoy

E. Basic skills
1. How to give one's word (pitfalls and gremlin tricks in this area are discussed)
2. Identifying barriers/obstacles (gremlins) that might prevent the individual from keeping their word
3. Identifying barriers/obstacles (gremlins) that keep the individual from enjoying the type of exercise the individual selected
4. Learning how to consistently defeat one's gremlins
5. Telling the truth about who really won each day

F. Basic training routine and schedule
1. Obtain physician clearance to exercise
2. Adopt a weekly game plan for exercise as described below
3. By Sunday (midnight) of the prior week, declare to yourself how many days you will exercise this coming week (write this down)
4. Each day of the coming week (by 10:00 AM), declare whether or not the individual will exercise that day and if exercising, the exact amount of exercise the individual will do
5. Once the individual has declared what they will do each day, mentally “lock in” this promise
6. Do not change, revoke, or otherwise alter the exercise promise once the individual has locked it in (unless the individual or another person might experience significant harm)
7. With regard to the written exercise promise each day, be sure to do exactly what was committed to (no more, no less), no matter what else happens in one's life
8. Given that life circumstances are unpredictable, the individual may need to use creativity, determination, imagination, and negotiation to keep to their goal each and every day
9. Use each day's declaration about exercise as an opportunity to notice which specific internal gremlins rise up to stop you
10. Use each day's declaration about exercise as an opportunity to prudently move through whatever gremlins the individual encounter so that the individual collects a “win” for the day
11. If the individual does not earn a “win” for the day, notice which specific gremlin(s) stopped them, what tactics were used, and how the individual could have defeated those gremlins
12. Repeat this same process on a daily basis for at least six weeks
13. Be careful not to accelerate the amount of exercise the individual does too quickly—the amount of exercise the individual does is not nearly as important, at this stage, as is the opportunity to practice giving one's word, identifying obstacles that might stop the individual and gaining the positive experience of successfully moving through those obstacles

Next, at the word-keeping competency testing step 214, an individual must successfully demonstrate mastery of keeping his/her word regarding exercise on a daily basis for a pre-determined period of time, preferably fourteen consecutive days. An individual is not allowed to move on (i.e. “graduate”) to subsequent steps of the method 100 until he/she has successfully completed this word-keeping competency step 214. The following outline presents the topics included as part of a typical competency-testing step 214:

A. After approximately six weeks of basic training through skill-building step 212, the individual may elect to begin word-keeping competency testing 214

B. Competency testing requires that the individual successfully give and keep their word regarding daily exercise for a predetermined time (preferably fourteen consecutive days).

C. Proof of competency, in the form of a daily written record of promises, outcomes, and personal barriers/obstacles identified must be supplied

D. If at any time during a fourteen day period, the individual fails to keep their word, the fourteen day testing period starts over again, beginning with the very next day

E. Competency training continues for as long as it takes to achieve 100% success for fourteen consecutive days

F. Proof of competency is required before the individual may move on to the behavior change module of this program

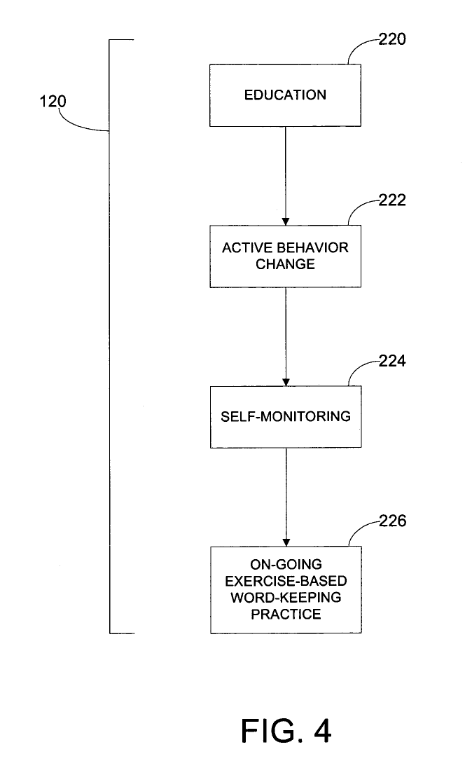

Once mastery over giving and keeping one's word has been consistently demonstrated in the physical exercise arena, an individual may then move on to an active behavior change phase 120 that, as shown in the flowchart of FIG. 4, typically comprises four steps; (1) education 220, (2) active behavior change 222, (3) self-monitoring 224, and (4) on-going exercise based word-keeping 226. In the active behavior change phase 120, that which was learned and the skills and personal self-awareness developed in the preparation phase 110 are applied to changing specific undesired behaviors, such as overeating, smoking, gambling, etc. An individual is free to choose any traditional human behavior modification program to supplement with the method 100 of the present invention, because the method 100 does not require any particular strategy to achieve self-selected goals.

Looking in detail at the behavior change phase 120, at the education step 220 an individual is taught how to win the “reach your goal” game. The following outline presents the topics included as part of a typical education step 220:

A. A biolinguistic model of human behavior and its implications for human behavior change is introduced. Key teaching points of this model are:
1. Established behavior patterns are in your body, not your mind
2. Established behavior pattern triggers may persist in your body forever (i.e. they may never go away)
3. Through the power of giving and keeping your word, the individual can resist these automatic, conditioned behavior triggers and choose to act in self-determined ways

B. Classic motivators of behavior change may work in the short run (to help the individual achieve his/her goals), but they are usually not sufficient to help the individual maintain those goals and avoid relapsing back into old behavior patterns

C. The best motivator for achieving and maintaining behavior change success is the desire to continue giving and keeping your word on a daily basis, day after day, week after week, month after month, year after year, decade after decade.

At the active behavior step 222, all of the knowledge and skills obtained by the individual in the preceding steps 210-220 are focused upon reaching the particular behavior change goals set by the individual. The following outline presents the topics included as part of a typical active behavior step 222:

A. Select a realistic and appropriate behavior change goal. For example, losing ten pounds and keeping it off.

B. Research available evidence based human behavior modification programs that have a high probability of allowing the individual to achieve their goal.

C. Select one or more evidence based human behavior modification program and create a personalized behavior change action plan. For example, a point system of dieting used by Weight Watchers, etc.

D. Apply the knowledge about personal gremlins, which the individual gained in their exercise based word-keeping basic training, to now keep their word regarding the specific elements of their behavior change action plan. For example, if one gremlin is the temptation to snack when returning home after work, not snacking becomes the word-keeping goal.

E. Apply other word-keeping skills which the individual acquired in the basic training part of the preparation module to stick to their chosen behavior change action plan.

During the self-monitoring step 224, the individual objectively measures and records his/her progress toward achieving his/her goals and adjusts his/her behavior change strategies accordingly. The following outline presents the topics included as part of a typical self-monitoring step 224:

A. Throughout the behavior change phase 222, individuals should monitor and record, by a method of their choosing, the results of their behavior change action plan on a daily basis

B. If the individual is adhering to his/her selected action plan and results are not being achieved in a reasonable period of time, make appropriate modifications to the action plan (or seek professional/expert advice) and continue daily monitoring to determine if progress is being made

C. If results are not being achieved, consider adopting a different behavior change strategy from the one the individual selected at the outset

D. If results are still not being achieved, despite several modifications or several different action plans, seek competent professional/expert evaluation and advice

Finally, during the on-going exercise based word-keeping step 226 of the behavior change phase 120, an individual continues to engage in daily physical exercise to further strengthen and deepen his/her ability to keep his/her word. The following outline presents the topics included as part of a typical ongoing word-keeping step 226:

A. While working on their specific behavior change action plan, continue to use daily exercise as a way to practice word keeping and gremlin identification skills

B. Also, continue using daily exercise to keep accumulating “wins” to add to their expanding experiential base of word keeping success

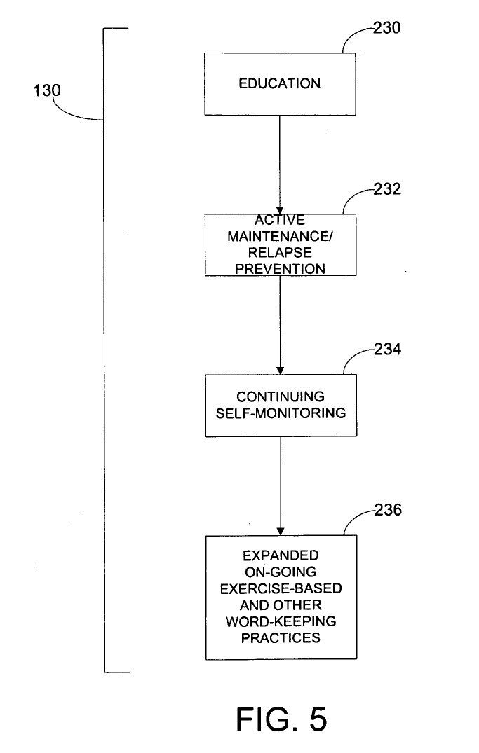

Once short-term goals have been achieved, an individual may then move on to a long-term maintenance/relapse prevention phase 130 that, as shown in the flowchart of FIG. 5, typically comprises four steps; (1) education 230, (2) active maintenance/relapse prevention 232, (3) continuing self-monitoring 234, and (4) expanded on-going word-keeping 236. During this maintenance/relapse prevention phase 130, an individual continues to use daily physical exercise to practice giving and keeping his/her word, regardless of what transpires in their day-to-day life.

At the educational step 230, an individual is taught how to win the “maintain their success” game. The following outline presents the topics included as part of a typical education step 230:

A. Classic motivators (which may have helped the individual achieve their behavior change goals) usually don't work to maintain their success or avoid gradual return to old behavior patterns (relapse)

B. Winning the “maintain your success” game has different requirements than winning the “reach your goals” game
1. Daily monitoring is essential
2. Alert/Alarm markers are essential
3. An action plan for dealing with early signs of relapse is required
4. A lasting, powerful motivation is required.
Unlike classic motivators, this maintenance motivator cannot be based upon any psychological, emotional, or physical factors which improve or disappear as an individual moves toward and achieves his/her targeted behavior change goals. The best motivator for this purpose is to continue playing, enjoying, and winning the “keep your word” game on a daily basis forever.

At the active maintenance/relapse prevention step 232, all of the knowledge and skills obtained by an individual in the preceding steps 210-230 are focused upon maintaining the success he/she has achieved, thereby preventing him/her from relapsing into old, undesirable behavior patterns. The following outline presents the topics included as part of a typical maintenance/relapse prevention step 232:

A. Research and develop an evidence based behavior change maintenance plan and incorporate the basic principles noted above

B. Research and design a relapse response/prevention plan including specific alarm and alert thresholds and corresponding “emergency” action plans

C. Monitor and record one's status on a daily basis

D. Make a chart of daily readings and display this chart where the individual and others (i.e. friends, family) can see it (if appropriate)

E. Set alert and alarm thresholds that will require the individual to activate their relapse prevention plan

F. Continue to use daily exercise as a way to practice word-keeping and gremlin identification skills

G. Also, continue using exercise to accumulate daily “wins” and build upon your experiential base of word keeping success

During the continuing self-monitoring step 234, an individual continues to monitor, indefinitely, key measures of his/her behavior change success while knowing, in advance, the specific actions he/she will take whenever pre-determined relapse “danger signs” appear. The following outline presents the topics included as part of a typical self-monitoring step 234:

A. Use the word-keeping skills developed in preceding phases to keep your word about monitoring your progress on a daily basis.

B. Use the word-keeping skills developed in preceding phases to keep your word about activating your relapse prevention plan when your threshold readings are reached or are temporarily exceeded.

Finally, during the expanded on-going word-keeping step 236 of this maintenance/relapse prevention phase 130, in addition to maintaining a daily physical exercise regimen as a means to continue practicing his/her daily word-keeping skills, an individual is encouraged to add additional word-keeping practices to further support and reinforce this highly important skill. The following outline presents the topics included as part of a typical expanded word-keeping step 236:

A. At this stage, consider adding other word keeping disciplines or “games” that the individual can use to practice keeping their word and beating their gremlins on a daily basis (e.g. the individual could play the “wear your automobile seat belt 100% of the time” game, or the “take the stairs rather than elevators or escalators” game)

B. In addition, the benefits of recognizing and learning to overcome personal barriers to keeping their word will begin to expand to every aspect of their life, not just the areas targeted for volitional behavior change

The present invention is intended to be a self-contained, short-term training/educational program. Training sessions are preferably conducted on a weekly basis. The sessions may be implemented in a face-to-face group format, or may be conducted individually, either face-to-face, telephonically, through written or other recorded media, or via the Internet.

The preparation phase 110 is preferably completed in six to eight weeks, but may require more time depending upon the progress made by an individual. If exercise based word-keeping competency is not readily achieved, as occurs with some individuals, the preparation phase 110 may be prolonged. The active behavior change phase 120 may last from eight weeks to one year or more, depending upon the individual and the specific goals selected (e.g. losing 200 pounds might easily take more than one year). It is anticipated that the behavior change training provided during the first two phases 110-120 of the present invention will be sufficient to give an individual the knowledge and skills required to successfully change any undesired behavior(s), on their own, for the rest of their lives.

The education step 230 of the maintenance/relapse prevention phase 130 is typically completed in four weeks. This training may be provided during the education step 220 of the behavior change phase 120, or immediately following that phase's successful completion. Obviously, the maintenance and relapse prevention phase 130 is practiced indefinitely, but continued participation in a structured behavior change program is not required.

In sum, the present method differs from the prior art by conditioning an individual to develop the essential skill of keeping his/her word consistently. This is accomplished by teaching goal-setting, enumeration of all psychological and emotional barriers to achieving the goals, and by reorientation to a game-play scenario by association of said barriers to “gremlins”, whereby the individual battles specific gremlins rather than generic or ill-defined obstacles. Moreover, the method begins by conditioning the foregoing in a novel exercise context—the use of physical exercise to help an individual learn how to give and keep his/her word on a consistent daily basis. This serves as a powerful training ground to assist an individual in discovering the means to identify and overcome the psychological and emotional barriers that prevent him/her from keeping his/her word.

The reorientation to game-play encourages the individual to think of behavior change as consisting of three separate yet interconnected “games”;

the keep your word game;

the reach your goal game; and

the maintain your success game.

Each of the games has different rules and requires a different set of skills and strategies to succeed. In order to succeed at long-term behavior change, an individual must learn how to master each of these three distinct games. In order to achieve this ultimate mastery, it is critical to recognize that the “keep your word” game is fundamental in that it is also required to win each of the other two games. Thus, behavior change programs which are built upon a strong word-keeping foundation are more likely to succeed than those which are not.

Once the type of personal discovery process and word-keeping success embodied in this invention is achieved in the physical exercise arena, an individual then transfers the very same skill-set and self-awareness to the keeping of daily promises associated with food intake, smoking behavior, sexual behavior, gambling behavior, etc. In addition, individuals are also provided with a new and improved “game plan” (e.g. strategies, concepts, motivation) for long-term behavior change success.

The method 100 of the present invention addresses one of the primary shortcomings in all traditional human behavior modification programs—that unless an individual experiences a lasting breakthrough in his/her ability to give and keep his/her word on a daily basis, even the best designed behavior change action strategies will ultimately fail. This forms the basis for the present invention's requirement that an individual demonstrates observable competency in the keeping of his/her word before he/she is allowed to tackle the challenges of changing the specific, undesired behaviors that have been targeted.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for encouraging behavior change in human beings comprising administering a three-phase sequence of steps, including:
an extended preparation phase, said preparation phase comprising the steps of;
screening potential users of said method to identify qualified users based on personal and health history information;
providing orientation information to said qualified users including purpose and rationale for participation;
providing preparatory education to said qualified users to educate said users about the stages of behavior change, the reasons why conventional behavior change methods can fail, and to introduce said users to core principles of the present method including quantification of internal barriers to keeping one's word; and game-play reorientation of internal barriers;
providing word-keeping skill-building information to said qualified users; and
testing word-keeping competency of said qualified users by requiring said users to commit to exercise goals and measuring the ability of said users to keep their word on a daily basis for a pre-determined period of time;
a behavior change phase, said behavior change phase comprising the steps of;
providing educational information to said competent users to instruct them how to attain a desired behavioral change by giving and keeping their word to implement said desired behavioral change on a daily basis;
pursuing said desired behavioral change by said competent users;
self-monitoring by said competent users of their progress in pursuing said desired behavioral change; and
conducting an on-going exercise-related word-keeping practice by said competent users by which they continue to commit to daily exercise goals and strive to keep their word on a daily basis; and
a maintenance/relapse prevention phase, said maintenance/relapse prevention phase comprising the steps of;
providing educational information to said competent users to instruct them how to maintain success and avoid returning to prior behavior patterns;
requiring said competent users to continue to pursue said desired behavioral change and maintain progress achieved;
preventing relapse into an undesired behavior by said competent users by requiring them to plan in advance specific actions said users will take whenever pre-determined relapse behavior patterns occur;
self-monitoring by said competent users of said steps of maintaining progress toward said desired behavioral change and preventing relapse into an undesired behavior; and
conducting an expanded word-keeping process by said competent users by requiring them to keep their word through daily exercise and said word-keeping practice.

2. A method for behavior change in humans according to claim 1, wherein said step of screening potential users comprises the substeps of:
completing an application form;
completing a health history questionnaire; and
obtaining clearance for said user to participate in said method from said potential user's primary care providers.

3. A method for behavior change in humans according to claim 1, wherein said step of providing orientation information to said qualified users comprises the substeps of:
providing background of traditional human behavior modification programs;
providing history of said method's inventor and development of said method;
explaining importance of word-keeping;
explaining negatives of behavior change programs that do not comprise of said word-keeping;
explaining importance of physical exercise as means for said word-keeping;
introducing concepts of word-keeping, reaching said user's goal; maintaining success; providing overview of said method's steps and content;
giving legal disclaimers for said method; and
explaining the risks of said method.

4. A method for behavior change in humans according to claim 1, wherein said step of providing preparatory information to said qualified users comprises the substeps of:
explaining obstacles to said word-keeping;
explaining how to win said word-keeping game, further comprising the steps of:
understanding the nature of said game, wherein said nature comprises said competent user's word versus said obstacles;
understanding rules of said game;
understanding said obstacles; and
understanding strategies to overcome said obstacles.

5. A method for behavior change in humans according to claim 1, wherein said step of providing word-keeping skill-building information to said qualified users comprising the substeps of:
introducing physical exercise as a daily routine to practice said word-keeping;
selecting said exercise;
reviewing premise of said word-keeping;
identifying said obstacles that might prevent said user from said word-keeping;
learning how to overcome said obstacles;
adopting weekly plan for said exercise;
following said weekly plan; and
identifying said obstacles that prevent said user from said word-keeping.

6. A method for behavior change in humans according to claim 1, wherein said step of testing word-keeping competency of said qualified users comprising the substeps of:
practicing said word-keeping for a predetermined time;
providing written proof of said word-keeping for said predetermined time;
starting said word-keeping again if said proof is not provided; and
achieving said word-keeping for said predeterminined time before proceeding to said behavior change phase.

7. A method for behavior change in humans according to claim 1, wherein said step of providing educational information to said competent users in said behavior change phase comprises the substeps of:
introducing a biolinguistic model of human behavior;
explaining negatives of classic methods; and
explaining that said word-keeping is the best motivator for both short-term and long-term success of said behavior change.

8. A method for behavior change in humans according to claim 1, wherein said step of pursuing a desired behavior change of said competent users in said behavior change phase comprises the substeps of:
selecting a realistic behavior change goal;
researching evidence based human behavior modification programs that have a high probability of allowing said user to achieve said goal;
selecting said evidence based human behavior modification program;
creating a personalized behavior change action plan based on said selected evidence based human behavior modification program; and
applying knowledge of obstacles which said user gained in said exercise-based word-keeping step, to word-keeping in said behavior change phase.

9. A method for behavior change in humans according to claim 1, wherein said goal is weight loss.

10. A method for behavior change in humans according to claim 1, wherein said goal is smoking cessation.

11. A method for behavior change in humans according to claim 1, wherein said goal is gambling avoidance.

12. A method for behavior change in humans according to claim 1, wherein said step of pursuing said on-going exercise based word-keeping of the behavior change phase comprises of the step of continuing to engage in said physical exercise to further strengthen said user's word-keeping ability.

13. A method for behavior change in humans according to claim 1, wherein said step of providing educational information of said maintenance/relapse prevention phase comprising the steps of;
explaining that daily self-monitoring of said user's ongoing status regarding said behavior
change goals is essential to said method;
explaining that defining specific alerts to warn of impending failure to maintain progress achieved is essential to said method;
designing an action plan for dealing with early signs of failure to maintain said progress achieved;
utilizing said word-keeping skills to adhere to a program of said daily self-monitoring;
utilizing said word-keeping skills to adhere to selected action plans if early signs of said impending failure appear;
explaining that classic behavior change motivators are often insufficient to sustain long-term behavior change;
explaining that the best motivator for said long-term behavior change is the continued joy and challenge of said word-keeping practice on a daily basis.

14. A method for behavior change in humans according to claim 1, wherein said method is a standalone program.

15. A method for behavior change in humans according to claim 1, wherein said method supplements traditional human behavior modification programs that begin with pre-contemplation and contemplation steps.

16. A method for encouraging behavior change in humans, comprising the steps of:
conditioning participants to give and keep their word by requiring them to commit to specific daily exercise goals, and monitoring their progress toward achieving said daily exercise goals;
requiring participants to recognize and then articulate their psychological and emotional barriers to achieving the daily exercise goals;
reorienting said participants toward achieving said daily exercise goals by creating a game-play scenario by association of said barriers with respective gremlins, and encouraging said participants to beat specific gremlins rather than generic psychological and emotional barriers;
after participants demonstrate a level of competency in beating specific exercise-related gremlins, conditioning said participants to give and keep their word with regard to a targeted behavioral change by requiring them to commit to a specific behavioral change on a daily basis;
requiring said participants to articulate their psychological and emotional barriers to achieving the specific behavioral change;
reorienting said participants toward achieving said specific behavioral change by creating a game-play scenario by association of said barriers with respective gremlins, and encouraging said participants to beat specific gremlins rather than generic psychological and emotional barriers;
monitoring the progress of said participants toward achieving said daily specific behavioral change.
